(19) United States
(12) Patent Application Publication
(10) Pub. No.: US 2004/0227108 A1
(43) Pub. Date: Nov. 18, 2004

(54) Wireless surveillance system

(75) Inventors: Juha Tuominen, Pirkkala (FI); Ville Nummela, Tampere (FI); Matti Vilkko, Tampere (FI)

Correspondence Address: Ladas & Parry, 26 West 61 Street, New York, NY, 10023, US

(73) Assignee: AILOCOM OY

(21) Appl. No.: 10/820,161

(22) Filed: Apr. 7, 2004

(30) Foreign Application Priority Data
Apr. 17, 2003 (FI) 20030595

(51) Int. Cl. G02B 27/00; G06M 7/00

(52) U.S. Cl. 250/551; 250/221

(57) ABSTRACT

A wireless surveillance system that comprises a base station and surveillance devices, such as cameras. The base station comprises a radio frequency transceiver and a power transmitter including a first and second light source and means for directing the first light source in a desired direction. The power of the second light source is substantially lower than that of the first, and it is transmitted parallel around the light emitted by the first light source. The surveillance device comprises a radio frequency transceiver and a power receiver including a first photo-detector for receiving emitted light and a second photo-detector for detecting the light emitted by the second light source. The surveillance device transmits a control signal to the base station, which first switches on the second light source and, in response to the control signal received from the surveillance device, switches on the first light source.

### FIELD OF THE INVENTION

The invention relates to wireless surveillance systems, and particularly to their power supply arrangements.

### BACKGROUND OF THE INVENTION

Various surveillance and monitoring systems utilizing camera monitoring have become more common during the last few years. A surveillance system comprising several, perhaps dozens of, cameras typically requires a great deal of cabling and wiring. The cameras require a transmission path for transmitting image data to the control point, and this transmission path is typically a telecommunications cable. The cameras also require power supply that is typically implemented by cabling from the public electrical power system, possibly through a transformer. Thus, a high percentage of the costs of a camera surveillance system, as high as over fifty percent, is made up of cabling and wiring. Fixed cabling also makes the alteration of a surveillance system or its shift temporarily to another control point very difficult.

However, arrangements are known, in which the surveillance cameras are wireless in the sense that the transmission path used for transmitting their image data is a wireless connection, for instance a short-range radio frequency connection. Several industry standards have already been developed for solutions based on the short-range radio frequency technique, examples of which are Bluetooth, WLAN (Wireless-Local Area Network) based particularly on the IEEE standard 802.11, and HomeRF. The image data of the surveillance cameras can be transmitted to the control point either directly or through a base station by utilizing one of these techniques, for instance.

A wireless telecommunications connection does not, however, remove the problem that to function, the cameras require power supply, i.e. typically an electric cable supply. Cameras can be made battery-driven, but the batteries need to be recharged at regular intervals. This, in turn, requires specific wiring for the charging arrangement, or else the batteries need to be detached each time for recharging and transferred for a separate charger. Therefore, especially in connection with wireless surveillance systems, there is also a need for wireless power supply.

However, in wireless power supply, there are several known problems. Various solutions based on inductive or radio frequency power transmission are very weak in efficiency, and at higher power, electromagnetic radiation may cause interference to other, surrounding devices. Implementing wireless power transmission by utilizing a light source, such as laser, enables better efficiency than radio frequency power transmission, for instance. A problem with wireless power transmission based on a light source is safety especially in the premises being monitored, in other words, in premises where people are present, since the power of a sufficiently efficient laser is substantially life-threatening. Even if significantly reduced, the power levels required for sufficient efficiency in a laser are high enough to at least severely damage vision in case of eye exposure.

### BRIEF DESCRIPTION OF THE INVENTION

It is thus an object of the invention to develop an improved method for wireless power transmission and an apparatus implementing the method such that the above-mentioned problems are solved. The object of the invention was achieved by a method, system, base station and surveillance device that are characterized by what is stated in the independent claims.

Preferred embodiments of the invention are disclosed in the dependent claims.

The invention is based on creating a wireless surveillance system that comprises a base station and at least one surveillance device, such as a camera. The base station comprises a radio frequency transceiver for establishing a telecommunications connection to said at least one surveillance device, and the surveillance device, such as camera, comprises means for generating surveillance data and a radio frequency transceiver for transmitting the surveillance data wirelessly to said base station. In addition, the base station comprises a power transmitter that comprises a first light source, and means for directing the light emitted by the first light source in a desired direction, and a second light source. The surveillance device, in turn, also comprises a power receiver that comprises a first photo-detector for receiving emitted light and transforming it into electric current, and a second photo detector. This way, the base station can wirelessly transmit power to the surveillance device by transmitting by means of the second light source in the power transmitter a substantially parallel light arranged around the light emitted by said first light source, the intensity of the light being substantially lower than the intensity of the light emitted by said first light source. The second photo-detector of the power receiver detects the light emitted by said second light source, and a control signal is transmitted from the surveillance device to the base station by means of said radio frequency transceiver in response to receiving the light emitted by said second light source. The first light source of the power transmitter is then switched on in response to receiving from the power receiver the control signal on the reception of the light emitted by the second light source.

According to a preferred embodiment of the invention, a control signal is transmitted from the power receiver to the power transmitter on the reception of the light emitted by the second light source at regular intervals. If a disturbance is detected in the light emitted by the second light source, the transmission of said control signal is ended, whereby the first light source of the power transmitter is switched off.

The method and system of the invention provide the advantage that the low-intensity light emitted by the second light source forms a “virtual insulator” around the higher-intensity light emitted by the first light source, and if the virtual insulator “breaks”, i.e. an obstacle blocks the light emitted by the second light source, the supply of the high-intensity light is switched off immediately, whereby the light cannot cause damage. Thus, the procedure of the invention makes safe wireless power transmission possible in a wireless surveillance system. Further, an advantage of the invention is that the power supply of the surveillance devices can advantageously be arranged to take place wirelessly from one base station in the same premises, so the installation and alteration of the system is easy and inexpensive. Another advantage of the invention is that the control signal is transmitted from a prior-art radio frequency transceiver in the base station and surveillance devices, which provides a fast and certain connection for the control signal and does not cause any additional costs. A yet further advantage of the invention is that it is possible to obtain a significantly better power transmission efficiency than in the prior-art solutions, substantially an efficiency of at least 20%.

### BRIEF DESCRIPTION OF THE FIGURES

The invention will now be described in greater detail by means of preferred embodiments and with reference to the attached drawings, in which

FIG. 1 is a block diagram of the basic structure of the system of the invention,

FIG. 2 is a schematic view of the properties of a few light sources and photo-detectors utilized in the invention,

FIGS. 3a and 3b show light source arrangements of a few embodiments of the invention,

FIG. 4 shows a procedure for finding receivers according to an embodiment of the invention,

FIG. 5 shows a procedure for performing power transmission according to an embodiment of the invention,

FIGS. 6a and 6b are block diagrams of a transmitter unit and receiver unit implemented according to an embodiment of the invention, and

Appendices 1 and 2 show a few values of the maximum permissible exposure of a laser beam by means of the standard ANSI Z136.1, Tables 5a and 5b.

### DETAILED DESCRIPTION OF THE INVENTION

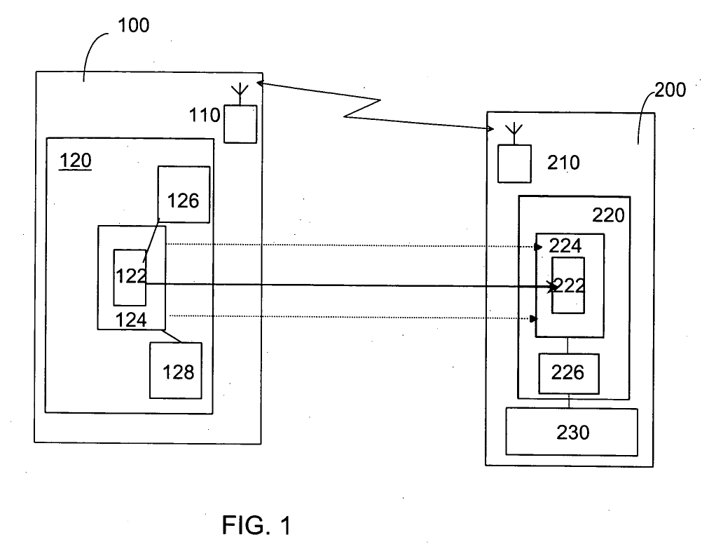

With reference to FIG. 1, the following shows the basic structure of the surveillance system of the invention. The surveillance system comprises a base station 100 and one or more surveillance devices 200, such as cameras or measuring instruments. The base station 100 comprises a transceiver 110 for establishing a radio frequency telecommunications connection to the surveillance devices 200 which, correspondingly, comprise a transceiver 210. The base station controls the operation of the surveillance devices through the telecommunications connection, and correspondingly, the surveillance devices transmit surveillance data, such as image data from the cameras, to the base station. The used radio frequency telecommunications connection can for instance be Bluetooth, IEEE 802.11-based WLAN, or HomeRF, the adaptation of which to data transmission is known per se to a person skilled in the art.

For wireless power transmission, the base station 100 comprises a power transmitter 120, and each surveillance device 200 correspondingly comprises a power receiver 220, which may further have connected thereto charging means 230 for the recovery of electric energy, typically a battery. The power transmitter 120 further comprises a first light source 122, a second, substantially lower-power light source 124, directional means 126 for directing the light emitted from at least the first light source 122 at the power receiver, and scanning means 128 for deflecting the light emitted from at least the second light source 124 into different directions for finding the power receivers. The transceiver 110 of the base station can preferably be utilized for the reception of a control signal. The power receiver 220 comprises a first photo-detector 222 for receiving the light emitted by the first light source 122, a second photo-detector 224 for receiving the light emitted by the second light source 124, and conducting means 226 for conducting the electric current transformed by the first photo-detector from the received light to the surveillance device 200 and to the charging means 230. Correspondingly, the transceiver 210 of the surveillance device can be used for transmitting a control signal to the power transmitter 120.

The power transmission process works in the system in a simplified manner as follows: the power transmitter 120 switches on the second light source 124, the transmission power of which is substantially so low that it does not cause danger to eyes, for example. If the power transmitter 120 is not already directed at the power receiver 220, this is done by means of the second light source 124 and the scanning means 128. The second light source 124 preferably comprises several separate low power light sources arranged in a circle around the first light source 122. This light emitted by the second light source, i.e. a group of several light sources, can be called a virtual insulator. Alternatively, the virtual insulator can be produced with one light source, the light emitted by which is expanded with a beam expander such that it spreads in a circle around the first light source 122.

To direct the power transmitter of the base station at the power receiver of the surveillance device, the power transmitter activates the virtual insulator and begins to scan the surroundings of the base station in the space where the base station is. Scanning is preferably performed as a predefined two- or three-dimensional systematic path that is repeated through the space surrounding the base station, until the virtual insulator comes into contact with the power receiver. The second photo-detector 224 of the power receiver is arranged to receive light at the same wavelength at which the virtual insulator is transmitted. When the virtual insulator comes into contact with the second photo-detector of the power receiver, the virtual insulator is directed at said photo-detector in a manner described later on.

When the virtual insulator is directed at the second photo-detector of the power receiver, the first light source 122 can be switched on in the power transmitter, the light emitted by which is transmitted surrounded by the virtual insulator and the light of which is used to perform the actual power transmission. The first photo-detector 222 of the power receiver is, in turn, correspondingly arranged to receive light on substantially the same wavelength that the first light source transmits. The first photo-detector 222 transforms the received light into electric current that is conducted on with the conducting means 226 to the surveillance device 200 and/or battery 230. The procedure of the invention provides a significantly better efficiency in power transmission than the prior-art solutions. The present light sources and photo-detectors can substantially achieve an efficiency of at least 20%.

The surveillance system is intended for use in premises, where people and for instance pets are present. Thus, if high power is used in the first light source 122 to generate the light, the generated light may be dangerous to eyes, for example, even if it is not on the wavelength of visible light. To prevent this, the system uses the above-mentioned virtual insulator, the task of which is to insulate the actual light beam intended for power transmission and to inform the system if the insulator ‘breaks’, i.e. an obstacle blocks the virtual insulator. In such a case, the power supply of the first light source is switched off immediately. When the obstacle to the first light source is removed, the power supply process can be restarted by first ensuring the alignment of the virtual insulator with the power receiver and, if the virtual insulator works properly, by then switching on the light beam used for power transmission.

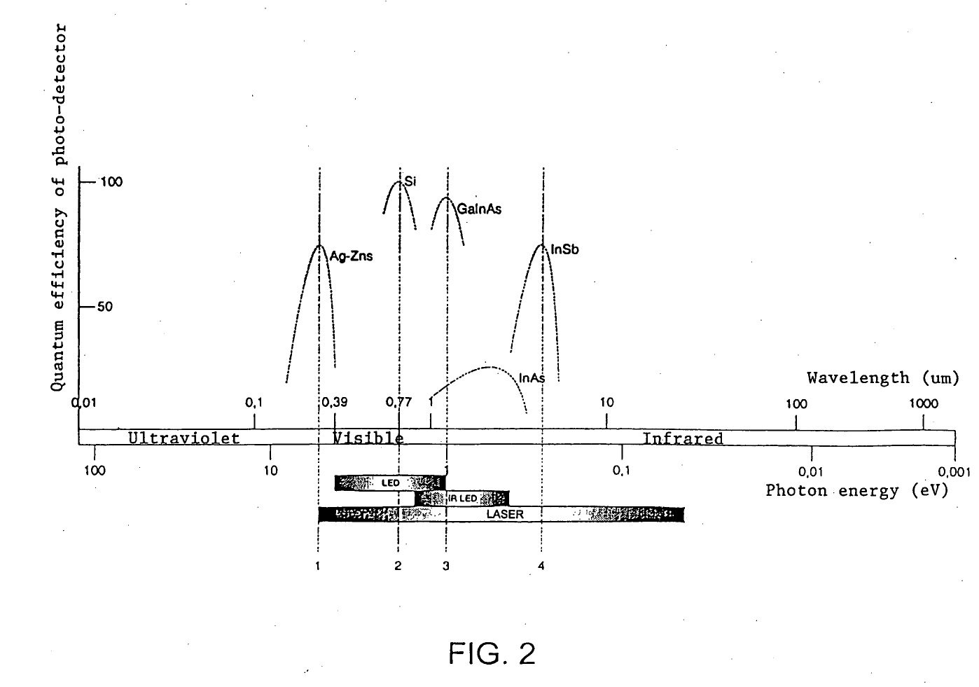

A light emitting diode LED or a laser, for instance, can be used as a light source in the system. The light source to be used and its wavelength shall be correspondingly matched with the photo-detector to be used. This is illustrated by the diagram according to FIG. 2, which shows the quantum efficiency of photo-detectors made of different materials, i.e. the efficiency of reception on different wavelengths of light. The vertical axis shows the quantum efficiency and the horizontal axis shows the wavelength of light and, correspondingly, the photon energy transmitted on the wavelength, the photon energy being inversely proportional to the wavelength. Further, FIG. 2 shows the wavelength ranges of a few presently used light sources.

FIG. 2 shows that if a maximum amount of power is to be transmitted, the shortest possible wavelength is preferred, because, this way, the amount of transmitted photon energy increases correspondingly. However, so as to be able to utilize the transmitted power, the used photo-detector shall be adapted to the corresponding wavelength. If the longest possible wavelength, or greatest photon energy, is to be used, a laser having a wavelength of substantially 0.30 um can be used as the light source, in which case an Ag-Zns photo-detector having a fairly high quantum efficiency can correspondingly be used as the photo-detector. Correspondingly, if the quantum efficiency is to be maximized, an Si photo-detector in the range of approximately 0.8 um can be used as the photo-detector, in which case a light emitting diode, laser or possibly LED operating in the infrared range can be used as the light source. It is also possible to use other material than those mentioned in FIG. 2 as the photo-detector in the invention. It should be noted that only preferred current light sources and photo-detectors applicable to the invention are described herein by way of example. The implementation of the invention is, however, not restricted to the used laser and/or photo-detector or the wavelengths these utilize, but as the technology advances, it is also possible to use as the light source and photo-detector components made of other materials and using other wavelengths.

When using lasers, the light to be transmitted, i.e. both the light of the virtual insulator and the power source, can be directly directed at the desired supply point. In such a case, the directing of the light source can be implemented for instance as processor-driven laser deflection, whereby the lasers are directly directed at the power receiver by using reversing mechanics and control electronics connected thereto. If the light sources are light emitting diodes LED, for instance, the directing can be done with mirrors by mirror-guided deflection. In such a case, the light source is preferably directed with a sufficient number of mirror servos that are controlled with a separate control unit. The deflection of lasers can also be done by mirror-guided deflection.

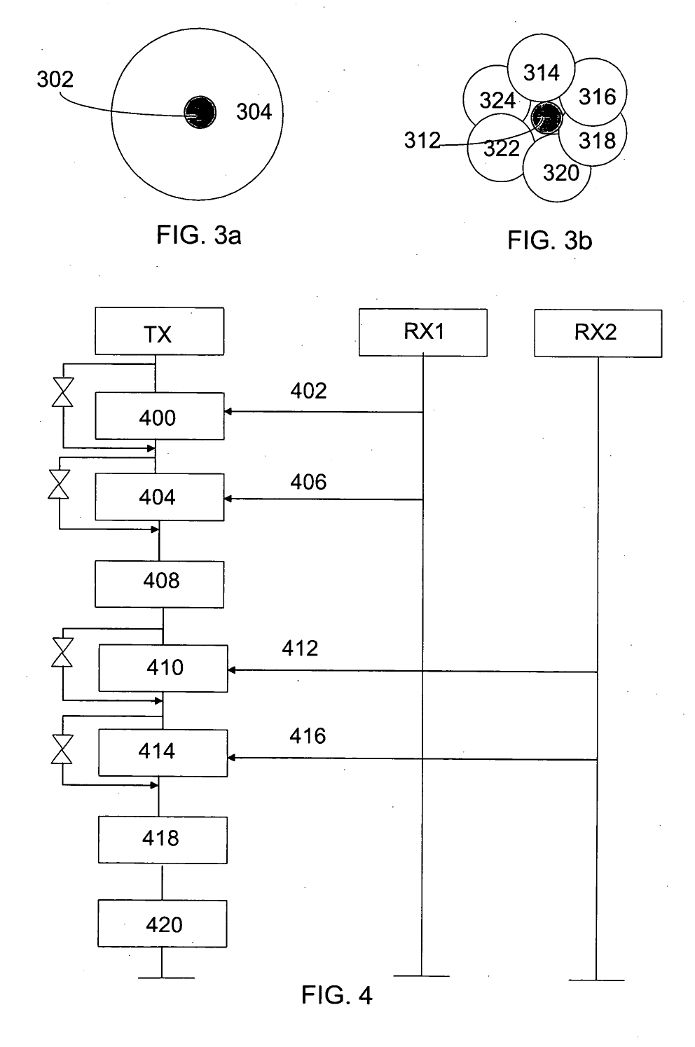

In directing the virtual insulator in particular, it is always possible to use a beam expander, with which the beam of a narrow light source is spread into a wider parallel beam. The beam expander comprises two lenses arranged to the power transmitter, of which the first lens spreads the beam coming from the light source. The second lens is arranged close to the first lens to collect the light beam spread by the first lens and to refract it to provide a parallel beam. A light beam of a light source that has a diameter of 1 mm, for instance, can thus be turned into a 5-mm light beam which is easier to direct at the photo-detectors of the power receiver. Thus, the virtual insulator can be made of one light source, the light emitted by which is expanded with the beam expander into a substantially round light curtain around the light emitted by the power source. This is illustrated in FIG. 3a that shows a curtain-like virtual insulator 304 around the power beam 302. Alternatively, the virtual insulator can be made up of several light sources that are all expanded with the beam expander into a round light curtain such that they overlap at least partly. This is correspondingly illustrated in FIG. 3b, which shows several expanded, curtain-like virtual insulator beams 314 to 324 around the power beam 312.

The virtual insulator can preferably be transmitted in light pulses at a very high frequency, for instance 10 to 100 MHz. The control of the operation of the virtual insulator can preferably be based on the fact that if the virtual insulator works properly, the power transmitter transmits a control signal to the base station at regular intervals. The control signal can preferably be transmitted from the surveillance device to the base station with the radio frequency transceiver 210 used for transmitting surveillance data. The control signal controlling the transmission of the power beam can be called a security link.

If the time between the reception of two control signals at the base station is too long, the power supply of the first light beam is switched off immediately. The transmission of the control signal can be controlled based on the fact, for instance, that it is easy to define reference levels that correspond to logical 0 and 1 for the light pulses of the virtual insulator. The photo-detectors of the virtual insulator preferably perform a logical AND operation on the received light pulses. If the result of the AND operation is 0, the reception of at least one virtual insulator beam was not successful. This probably means that an obstacle blocks the light emitted by at least one light beam in the virtual insulator. The transmission of the control signal from the power receiver is switched off immediately. Because the pulses are transmitted at a high frequency, the switching off of the control signal transmission is also very fast.

Correspondingly, if one virtual insulator light source is used, the light emitted by which is spread with a beam expander around the power beam, the control signal can be controlled on the basis of the light pulses received in the photo-detector of the virtual insulator. The photo-detector of the virtual insulator then monitors the received pulses and if the reception frequency of the pulses changes, i.e. the time between two received consecutive pulses is substantially at least twice the default time, this probably means that an obstacle blocks the light emitted by at least one light beam in the virtual insulator. The transmission of the control signal from the power receiver is then switched off immediately.

Further, check data encoded into the light pulses of the virtual insulator can be used in determining the integrity of the virtual insulator. The check data shall be encoded in an encoding manner that enables the detection of a rising or trailing edge of a pulse-encoded bit and the determination of the temporal duration of one bit such that the maximum pause between two consecutive edges is known. One suitable encoding method is Manchester encoding, in which bit values are defined such that, in the middle of each bit sequence, there is a shift from zero to one (rising edge) or one to zero (trailing edge). The length of the bit sequence is predefined, and sampling takes place in the middle of the bit sequence, at which time the shift also takes place. A rising edge detected in sampling gives one as the bit value and a trailing edge correspondingly gives zero as the bit value. In each bit sequence, a pulse representing the value one and a pulse representing the value zero is detected, and the bit value is determined on the basis of their relative order.

Thus, the check data to be transmitted with the virtual insulator can be encoded such that the value one is encoded into the pulsed signal by transmitting a light pulse, the length of which is half of the length of the bit sequence, and the value zero is encoded by interrupting the transmission of light for a half of a bit sequence. The bit values of the check data are determined on the basis of the order of these signal values 1/0. The check data is preferably a predefined bit sequence that the receiver is to receive as pulses of the virtual insulator. This preferably provides an extra check on the integrity of the virtual insulator, in which case for instance random diffuse reflection in the reception of the virtual insulator can be interpreted as error reception.

The power transmitter is preferably given a time limit representing the maximum length of the time between two received controls signals. The time limit is, in turn, determined on the basis of the time of the power beam defined as safe for the eye, i.e. maximum permissible exposure (MPE). Maximum permissible exposure is a function of the wavelength and power density (W/cm²) of the light beam used to transmit power. The standard ANSI Z136.1, some example values of which are shown in appendices 1 and 2, defines these values in more detail. The base station 100 preferably comprises regulating means connected to the transceiver 210 to monitor the reception of the control signal. If the reception of the control signal in the transmitter is delayed over the predefined time (in other words, one control signal is not received), the regulating means immediately switch off the power supply to the first light source 122 of the power transmitter or at least reduce the supplied power substantially.

As earlier stated, the virtual insulator can be used to find and direct the power receivers. To direct the power transmitter at the power receiver, the power transmitter activates the virtual insulator and begins to scan the surroundings of the base station in the space where the base station is. The surveillance devices, such as cameras, in the space, to which the power receivers are connected, then run on their batteries. The scanning is performed as a predefined path that is repeated through the space surrounding the base station, until the virtual insulator comes in contact with the power receiver of the surveillance device. When the virtual insulator comes in contact with the second photo-detector of the power receiver, the power receiver informs the power transmitter of this through the security link. Because the scanning is preferably performed at a high rate, the directing can be performed such that the security link indicates the momentary connection with the virtual insulator, which is naturally received at the base station after a slight delay. The power transmitter then stops the scanning process and moves the virtual insulator slowly backwards the distance traveled during said delay until the connection is re-established. After this, the power transmitter defines the location coordinates of the power receiver of the surveillance device and, if necessary, continues the search for other power receivers in the space in question.

It should thus be noted that one base station could preferably supply power wirelessly to the power receivers of several surveillance devices. FIG. 4 shows an MSC diagram that illustrates the search for power receivers in a space having two surveillance devices. The power transmitter TX first activates the virtual insulator and performs a scan with it at a high rate (400). The virtual insulator is momentarily in contact with the photo-detector of the virtual insulator in the power receiver RX1 of the first surveillance device, and the power receiver RX1 transmits a security link notification to the power transmitter TX (402). The power transmitter TX stops scanning and slowly returns to re-direct the virtual insulator at said photo-detector (404). When the directing is correctly performed, the security link is re-started (406). The power transmitter TX defines the coordinates of the photo-detector of the virtual insulator in the power receiver RX1 of the first surveillance device and stores them into the memory of the base station (408), after which the power transmitter TX continues to scan the space with the virtual insulator still activated (410). The virtual insulator again momentarily comes in contact with the photo-detector of the virtual insulator in the power receiver RX2 of the second surveillance device, and the power receiver RX2 quickly transmits the security link notification to the power transmitter TX (412). The power transmitter TX again stops scanning and slowly returns to re-direct the virtual insulator at the photo-detector of the second power receiver RX2 (414). When the directing is correctly performed, the second power receiver RX2 restarts the security link (416). The power transmitter TX defines the coordinates of the photo-detector of the virtual insulator in the power receiver RX2 of the second surveillance device and stores them into the memory of the base station (418), after which the power transmitter TX continues to scan the space. When the power transmitter TX has scanned the entire space, it stops scanning, notes that the power supply points have been found and deactivates the virtual insulator (420).

If new devices are brought into the space, and wireless power supply needs to be arranged for them, the scanning process of the power transmitter TX is re-started. Alternatively, the power transmitter TX can make an automatic scan at specific intervals. The location coordinates of the new devices are defined correspondingly using scanning, after which the power transmitter TX stores the coordinates into the memory of the base station. The coordinates of the existing devices in the space are already stored into the memory of the base station, so during new scanning cycles, the old devices can preferably be ignored, which speeds up the scanning of the space.

According to a preferred embodiment of the invention, the scanning process described above can be sped up by utilizing the radio connection used as the security link in the searching and directing of the power receivers. The power receiver can then register to the power transmitter by establishing a radio connection to the power transmitter and by transmitting for instance its device identifier at the same time. The power receiver also preferably comprises a light emitting diode operating in the infrared range (IR-LED), in which case, in response to the registration message, the power transmitter transmits an acknowledgement to the power receiver and asks it to switch on the IR-LED. The power transmitter in turn comprises a position sensing detector (PSD) diode and a wide-angle optic, such as a wide-angle lens, connected to it. By means of the PSD diode, an approximate location of the power receiver's IR-LED can be defined very quickly. When the power transmitter has defined the approximate location of the power receiver's IR-LED, it activates the virtual insulator and directs it towards the approximate location of the power receiver and begins scanning in the manner described above. This way, it is possible to significantly speed up the finding of the power receiver from the surrounding space, because the positioning is started in response to the registration of the power transmitter, and the actual scanning can be done immediately in approximately the correct direction and the entire space need not be scanned.

The actual power transmission to several surveillance devices is done by supplying power to each supply point for a specific time, after which the first light source (power source) of the power transmitter is switched off and the virtual insulator is directed at the next supply point. This can preferably be done without scanning, because the coordinates of the supply points are already defined earlier and stored into the memory of the base station. When the virtual insulator is directed at the photo-detector of the virtual insulator in the next power receiver, said power receiver sets up the security link, by which the power transmitter knows that the directing was achieved without problems and it can switch on the first light source (power source). The power transmitter again supplies power for a specific time, switches off the power source and moves on to the next supply point.

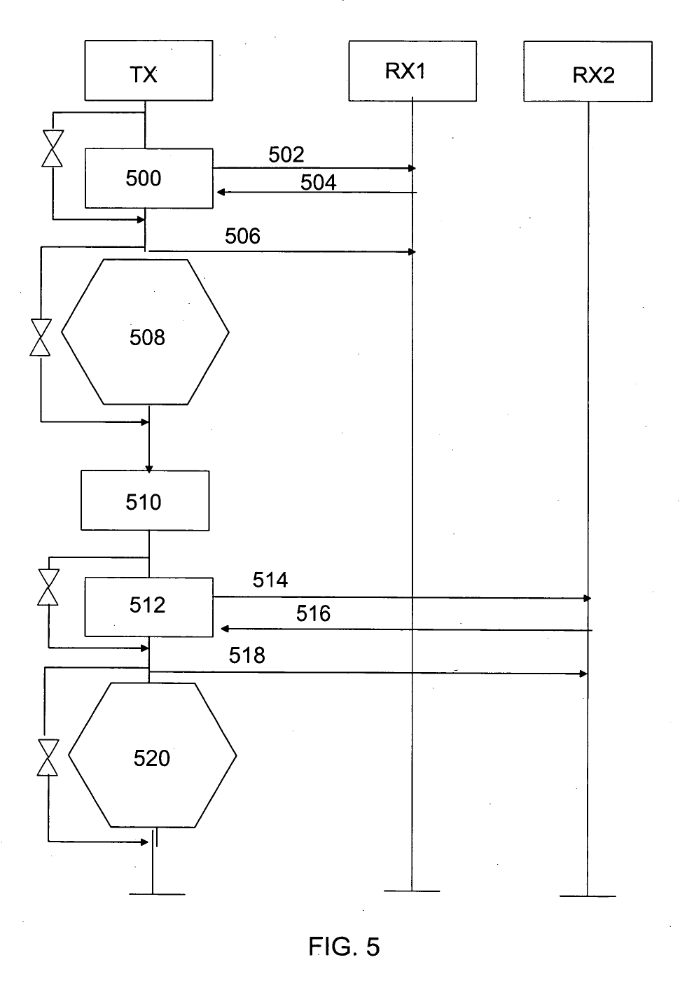

This process is illustrated with the MSC diagram of FIG. 5, which shows a power transmission process to the power receivers of two different surveillance devices. The location coordinates of the power receivers RX1 and RX2 of both surveillance devices are stored into the memory of the base station during the scanning process described above. On the basis of these location coordinates, the power transmitter TX directs (500) the activated virtual insulator at the photo-detector of the virtual insulator in the power receiver RX1 of the first surveillance device (502), and, in response to this, the power receiver RX1 sets up the security link (504). From the received security link signal, the base station knows that the directing is correctly performed and the virtual insulator is intact, so the power transmitter TX switches on the power source and transmits power by means of the emitted light to the first power receiver RX1 (506). The power transmitter TX emits light for a predefined time, after which the power source is switched off (508). Before directing at the next supply point, the power transmitter also switches off the virtual insulator (510).

Next, the power transmitter TX is directed (512) at the power receiver RX2 of the second surveillance device, and the virtual insulator is activated (514), and, in response thereto, the power receiver RX2 sets up the security link (516). Again, on the basis of the received security link signal, the base station knows that the directing is correctly performed and the virtual insulator is intact, so the power transmitter TX switches on the power source and transmits power by means of the emitted light to the second power receiver RX2 (518). The power transmitter TX emits light to the power receiver RX2 for a predefined time, after which the power source is switched off (520). It should be noted that power supply times of different lengths could be defined for different power receivers (RX1/RX2). The preferred power supply time of each power receiver can be indicated to the base station in information attached to the security link signal, for instance. Correspondingly, the base station comprises means for detecting the information defining the power supply time and means for defining the actual power supply time to be used for each receiver, which time depends on several factors, such as the power requested by the receivers, the number of receivers, the time required for re-direction, etc. The power transmitter TX again deactivates the virtual insulator and returns to the power receiver RX1 of the first surveillance device to continue power supply to it, because no other power receivers are used in the space.

The virtual insulator is preferably implemented using relatively low power lasers that function at a different wavelength than the actual power source. Such lasers are inexpensive, and the light they produce is already coherent, whereby separate directing means are not needed and the light, which is emitted at a different wavelength, does not cause error situations in the photo-detector of the actual power transmission light. The virtual insulator can be formed using a single light source, the light emitted by which is expanded using a beam expander to form a substantially round light curtain around the light emitted by the power source, as illustrated above in FIG. 3a. Alternatively, the virtual insulator may preferably comprise a few lasers, 5 to 7 for example, arranged into a circle around the actual power transmission beam, the laser beams being each expanded with the beam expander to form a round light curtain in which the beams at least partly overlap, as shown in FIG. 3b. The number of lasers is then sufficient to ensure the safe operation of the virtual insulator such that should the power transmission beam be blocked from whatever direction, the security link and, subsequently, the power transmission beam would be switched off in good time.

The photo-detector of the virtual insulator is preferably ringshaped, the mutual position of the transmitter and the receiver thus having no impact on the detection of the light beams of the virtual insulator at the detector. On the other hand, the photo-detector ring is preferably as wide as possible to allow the virtual insulator to be detected and the power transmission to be carried out successfully although the received light beams arrive from a very skew angle.

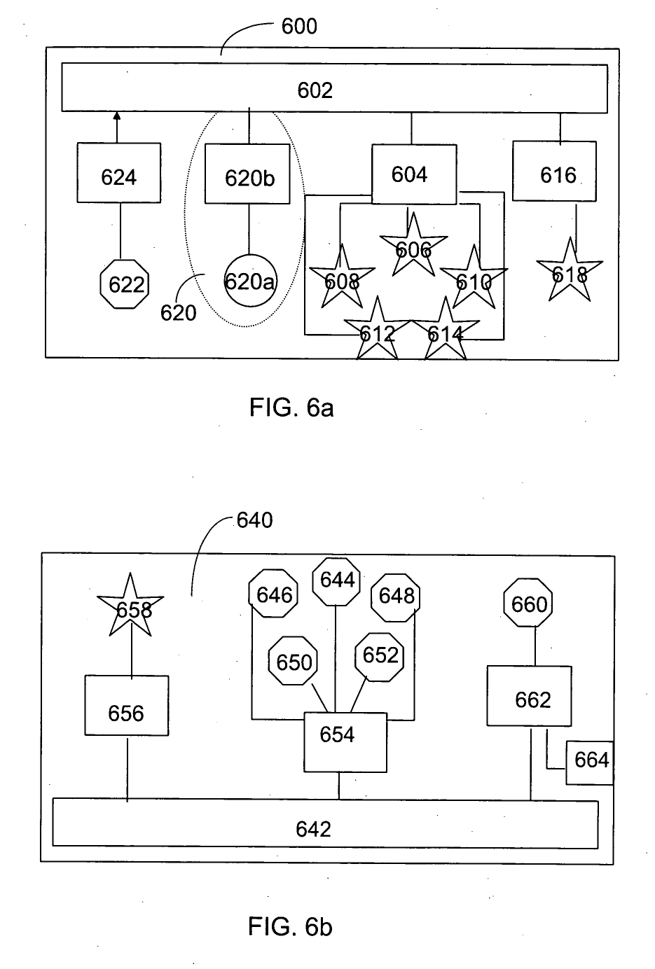

FIGS. 6a and 6b are simplified views of functional blocks of a power transmitter unit 600 and a power receiver unit 602 of the invention. The power transmitter unit 600 comprises a transmitter control logic 602 that can be advantageously implemented for example as programmable ICs, software, or as a combination of these. During the operation of the device, the control logic 602 controls the supply control 604 of the virtual insulator, the supply control controlling the low power lasers 606, 608, 610, 612 and 614 of the virtual insulator. In addition, the control logic 602 controls a supply control circuit 616 of the power laser during the operation of the device, the circuit controlling the operation of the actual power source (laser) 618. Further, the control logic 602 controls the deflection of the lasers of both the virtual insulator and the power source to the desired supply point. The deflection is carried out by a deflection unit 620 which can be implemented for example as a processor-driven laser deflection, in which case the lasers themselves are directed directly at the receiver by using reverse mechanics and control electronics connected thereto, or as a mirror-guided deflection, the directing being then carried out with mirrors, if light emitting diodes LED, for example, are used as light sources. The deflection unit 620 in question preferably comprises a sufficient number of mirror servos 620a and a control unit 620b controlling them. An essential element in the safe operation of the transmitter unit 600 is a security link receiver 622, which can be a radio frequency transceiver comprising a base station. The received security link signal is fed into the control unit 602 that monitors the reception times of consecutive security link signals and, if necessary, switches off the supply from the power source 618.

FIG. 6b in turn illustrates the functional blocks of a power receiver unit 640 of the invention. The receiver unit 640 also comprises a control logic 642 that can be implemented for example as programmable ICs, software or as a combination of these. Laser beams transmitted by low power lasers of the power transmitter unit are received from photo-detectors 644, 646, 648, 650 and 652 of the virtual insulator, the laser beams are combined and amplified in an amplifier 654. From the combined signal arriving from the amplifier, the control logic of the power receiver concludes whether the virtual insulator is intact and, if it is, the logic instructs a supply circuit 656 of the security link to start transmitting at regular intervals the security link signal through the transmitter 658. The radio frequency transceiver in the surveillance device can be used as the transmitter. The photo-detector 660 of the power laser serves as the receiver of the actual transmitted power, and from there the electric current converted from the light power received from the photo-detector is supplied through a control unit 662 of charging to an interface 664 and from there on either to the surveillance device or to charging means, such as a battery.

The power transmission system described above can be used in different surveillance and alarm systems, in which wired power supply to the surveillance devices may be difficult to arrange. These include for example wireless surveillance cameras, motion detectors, diverse surveillance and measuring sensors and alarm devices. Naturally the application of the system is not restricted to the above examples.

It is apparent to a person skilled in the art that as technology advances, the basic idea of the invention can be implemented in various ways. The invention and its embodiments are therefore not restricted to the above examples, but they may vary within the scope of the claims.

1. A method for supplying power in a wireless surveillance system that comprises a base station and at least one surveillance device, such as a camera,
the base station comprising a radio frequency transceiver for establishing a telecommunications connection to said at least one surveillance device, a power transmitter that comprises a first light source and means for directing the light emitted from the first light source in a desired direction, and a second light source; and
the surveillance device, such as camera, comprising means for generating surveillance data and a radio frequency transceiver for transmitting the surveillance data wirelessly to said base station, a power receiver that comprises a first photo-detector for receiving emitted light and transforming it into electric current, and a second photo detector; the method comprising
transmitting by means of the second light source in the power transmitter a substantially parallel light arranged around the light emitted by said first light source, the power of the light being substantially lower than the power of the light emitted by said first light source,
detecting by means of the second photo-detector of the power receiver the light emitted by said second light source,
transmitting a control signal from the surveillance device to the base station by means of said radio frequency transceiver in response to receiving the light emitted by said second light source, and
switching on the first light source of the power transmitter in response to receiving from the power receiver the control signal on the reception of the light emitted from the second light source.

2. A method as claimed in claim 1, comprising
transmitting said control signal from the power receiver to the power transmitter at regular intervals on the reception of the light emitted by the second light source at regular intervals,
ending the transmission of the control signal in response to detecting a disturbance in the light emitted by the second light source, and
switching off the first light source of the power transmitter.

3. A method as claimed in claim 1, comprising
transmitting the light emitted by the second light source in pulses,
ending the transmission of the control signal in response to the time between two consecutive pulses received by the power receiver being at least twice the inverse value of the transmission frequency of the pulses.

4. A method as claimed in claim 1, comprising
registering the power receiver to the power transmitter before power transmission by transmitting from the power receiver a registering message by means of the control signal.

5. A method as claimed in claim 4, comprising
switching on in the power receiver a LED operating in the infrared range after said registering message is transmitted.

6. A method as claimed in claim 5, comprising
determining the location of said power receiver by using a PSD diode in the power transmitter, the diode being arranged to detect in the power receiver the LED operating in the infrared range in response to the reception of said registering message.

7. A method as claimed in claim 1, comprising
deflecting the light emitted by the second light source of the power transmitter according to a predefined route in the space surrounding the power transmitter to search for the power receivers.

8. A method as claimed in claim 1, comprising
transmitting the light of the second light source at a level that is substantially so low as not to damage the eye.

9. A wireless surveillance system that that comprises a base station and at least one surveillance device, such as a camera,
the base station comprising a radio frequency transceiver for establishing a telecommunications connection to said at least one surveillance device, a power transmitter that comprises a first light source and means for directing the light emitted by the first light source in a desired direction, a second light source, the light emitted by which is substantially lower in power than the light emitted by the first light source, and which emitted light is arranged to be transmitted substantially parallel around the light emitted by the first light source,
the surveillance device, such as camera, comprising means for generating surveillance data and a radio frequency transceiver for transmitting the surveillance data wirelessly to said base station, a power receiver that comprises a first photo-detector for receiving emitted light and transforming it into electric current, and a second photo-detector for detecting the light emitted by the second light source, and, in response to the detection, the surveillance device is arranged to transmit a control signal to the base station by means of the radio frequency transceiver,
whereby the base station is arranged to first switch on the second light source of the power transmitter and, in response to receiving said control signal on the reception of the light emitted by the second light source, the base station is arranged to switch on the first light source of the power transmitter.

10. A surveillance system as claimed in claim 9, wherein
the power receiver is arranged to transmit said control signal to the power transmitter on the reception of the light emitted by the second light source at regular intervals, and, in response to detecting a disturbance in the light emitted by the second light source, to end the transmission of the control signal,
whereby the power transmitter is arranged to switch off the first light source.

11. A surveillance system as claimed in claim 9, wherein
the power receiver is arranged to register to the power transmitter before power transmission by transmitting by means of said control signal a registering message.

12. A surveillance system as claimed in claim 11, wherein
the power receiver comprises a LED operating in the infrared range that is arranged to be switched on after the registering message is transmitted.

13. A surveillance system as claimed in claim 12, wherein
the power transmitter comprises a PSD diode that is arranged to detect in the power receiver the LED operating in the infrared range in response to receiving said registering message in the power transmitter.

14. A surveillance system as claimed in claim 9, wherein
the power transmitter comprises deflecting means for deflecting the light emitted by the second light source according to a predefined route in the space surrounding the power transmitter to search for the power receivers.

15. A wireless base station in a surveillance system, which comprises a radio frequency transceiver for establishing a telecommunications connection to at least one surveillance device, wherein
the base station comprises a power transmitter that comprises a first light source and means for directing the light emitted by the first light source in a desired direction, a second light source, the light emitted by which is substantially lower in power than the light emitted by the first light source, and which emitted light is arranged to be transmitted substantially parallel around the light emitted by the first light source,
and the base station is arranged first to switch on the second light source of the power transmitter and, in response to receiving from the surveillance device through the radio frequency transceiver a control signal on the reception of the light emitted by the second light source, the base station is arranged to switch on the first light source of the power transmitter.

16. A wireless surveillance device, such as camera, in a surveillance system, which comprises means for generating surveillance data and a radio frequency transceiver for transmitting the surveillance data wirelessly to a base station of the surveillance system, wherein
the surveillance device comprises a power receiver that comprises a first photo-detector for receiving the light emitted by a first light source of a power transmitter in the base station and transforming it into electric current, and a second photo detector for detecting the light emitted by a second light source of the power transmitter in the base station,
whereby, in response to the detection, the surveillance device is arranged to transmit a control signal to the base station by means of the radio frequency transceiver.
